(19) United States
(12) Patent Application Publication
(10) Pub. No.: US 2024/0383771 A1
(43) Pub. Date: Nov. 21, 2024

(54) NCA POSITIVE ELECTRODE MATERIAL PRECURSOR HAVING CORE-SHELL STRUCTURE, METHOD FOR PREPARING SAME, AND USE THEREOF

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Haijun Yu, Foshan, Guangdong (CN); Yinghao Xie, Foshan, Guangdong (CN); Aixia Li, Foshan, Guangdong (CN); Xuemei Zhang, Foshan, Guangdong (CN); Changdong Li, Foshan, Guangdong (CN)

(21) Appl. No.: 18/687,301

(22) PCT Filed: Feb. 8, 2023
(86) PCT No.: PCT/CN2023/074952

§ 371 Date: Feb. 28, 2024

(30) Foreign Application Priority Data
Apr. 25, 2022 (CN) 202210438085.6

(51) Int. Cl. C01G 53/00; H01M 10/0525

(52) U.S. Cl. CPC C01G 53/42; H01M 10/0525; C01P 2004/03; C01P 2004/51; C01P 2004/61; C01P 2004/84; C01P 2006/40; C01P 2006/90

(57) ABSTRACT

Disclosed in the present invention are an NCA positive electrode material precursor having a core-shell structure, a method for preparing same, and use thereof. The precursor is a spherical or spheroid particle and consists of an outer shell and an inner core. The outer shell has a chemical general formula of NiₐCo_{b}Al_{c}(OH)_{2+c}, wherein a+b+c=1, 0.45≤a≤0.55, 0.15≤b≤0.25, and 0.25≤c≤0.35; the inner core has a chemical general formula of NiₓCo_{y}Al_{z}(CO₃)_{1-z}(OH)_{3z}, wherein x+y+z=1, 0.85≤x<0.98, 0<y≤0.15, and 0<z≤0.15. The inner core has a porous structure. The inner core in the precursor of the present invention has a high nickel content and a porous structure, which can effectively buffer the volume change caused by subsequent charging and discharging of the NCA positive electrode material. The outer shell is a low-nickel material, which alleviates the volume change caused by the high nickel content.

### TECHNICAL FIELD

The present disclosure belongs to the technical field of cathode materials for lithium-ion batteries (LIBs), and in particular relates to a nickel-cobalt-aluminum (NCA) cathode material precursor with a core-shell structure, and a preparation method therefor and use thereof.

### BACKGROUND

LIBs are widely used due to their advantages such as prominent cycling performance, high capacity, low price, convenient use, safety, and environmental friendliness. With the increasing market demand for high-performance (such as high energy density) batteries and the continuous popularization of electric vehicles, the market demand for battery cathode materials has presented a rapid growth trend. Ternary cathode materials are the most potential and promising materials among the current mass-produced cathode materials due to their characteristics such as high energy density, relatively-low cost, and excellent cycling performance. Among ternary cathode materials, NCA ternary materials not only have high reversible specific capacity and low material cost, but also exhibit enhanced structural stability and safety due to the aluminum (Al) doping, which improves the cycling stability of the materials. NCA materials are also one of the most popular ternary materials currently studied.

Although some performance indexes of the current NCA materials are excellent, it is difficult for the materials to be prepared, and the materials exhibit the shortcomings of high-nickel ternary materials, such as poor cycling performance, which are caused by lithium-nickel disordering, high surface residual alkali content, and gas expansion.

The Al doping can stabilize a layered structure of a material to improve the cycling life and thermal stability of the material. A layered structure of an NCA layered material is relatively stable compared with other materials, but still will undergo structural changes and capacity loss during a charge-discharge process due to the reduction of O—Ni—O interlayer spacing during phase transition. In particular, many NCA materials currently prepared have a relatively high tap density and a compact internal structure, and are prone to uneven volume change during a charge-discharge process, which results in irreversible capacity loss of the materials. However, a synthesis technology of a precursor of an NCA cathode material determines 60% to 70% of the performance of the NCA cathode material, and thus the improvement of precursor materials for NCA ternary materials is an urgent problem to be solved in the art.

At present, a lithium nickel cobalt aluminium oxide precursor is mainly prepared by a one-step or multi-step co-precipitation method, with an inorganic aluminum salt and an inorganic nickel-cobalt salt as metal sources and an inorganic alkali (sodium hydroxide or aqueous ammonia) as a precipitating agent. For example, Chinese patent application CN106992285A discloses a preparation method for an NCA ternary precursor, where an aluminum ingot is allowed to react with excess sodium hydroxide to prepare a sodium metaaluminate solution, and then the sodium metaaluminate solution, a nickel-cobalt salt aqueous solution, a complexing agent, and a precipitating agent are added to a reactor to allow a reaction to obtain an NCA hydroxide. However, there are still problems such as compact internal structure and large irreversible capacity loss.

### SUMMARY

The present disclosure is intended to solve at least one of the above-described technical problems existing in the prior art. In view of this, the present disclosure provides an NCA cathode material precursor with a core-shell structure, and a preparation method therefor and use thereof. The precursor material prepared by the preparation method has an obvious loose core-shell structure with a high nickel content in the core, which can buffer a volume change during a charge-discharge process of a cathode material.

According to an aspect of the present disclosure, an NCA cathode material precursor with a core-shell structure is provided, where the NCA cathode material precursor is a spherical or spheroidal particle and is consisting of a shell and a core; the shell has a general chemical formula of NiₐCo_{b}Al_{c}(OH)_{2+c}, where a+b+c=1, 0.45≤a≤0.55, 0.15≤b≤0.25, and 0.25≤c≤0.35; the core has a general chemical formula of NiₓCo_{y}Al_{z}(CO₃)_{1-z}(OH)_{3z}, where x+y+z=1, 0.85≤x≤0.98, 0<y≤0.15, and 0<z≤0.15; and the core has a porous structure, with a porosity of 15% to 45%.

In some embodiments of the present disclosure, the NCA cathode material precursor may have a particle size D50 of 5.0 μm to 15.0 μm, and D50 of the core may be 2.0 μm to 5.0 μm.

The present disclosure also provides a preparation method for the NCA cathode material precursor with a core-shell structure described above, including the following steps:
S1: adding a soluble barium salt to a first nickel-cobalt-aluminum mixed solution to obtain a mixed metal solution, mixing the mixed metal solution with urea, and allowing a hydrothermal reaction, where nickel, cobalt, and aluminum in the first nickel-cobalt-aluminum mixed solution are in a molar ratio of x:y:z;
S2: after the hydrothermal reaction in S1 is completed, introducing carbon dioxide into a reacted system to allow a further reaction under a pressure of 3.0 MPa to 5.0 MPa, and after the further reaction is completed, conducting solid-liquid separation (SLS) to obtain the core; and
S3: adding the core to a base solution, concurrently feeding a second nickel-cobalt-aluminum mixed solution, a sodium hydroxide solution, and aqueous ammonia to allow a reaction, and when a particle size of a product of the reaction reaches a target value, conducting SLS to obtain the NCA cathode material precursor, where the base solution is a mixed solution of sodium hydroxide and aqueous ammonia, and nickel, cobalt, and aluminum in the second nickel-cobalt-aluminum mixed solution are in a molar ratio of a:b:c.

In some embodiments of the present disclosure, in S1, a total concentration of metal ions in the first nickel-cobalt-aluminum mixed solution may be 0.1 mol/L to 1.0 mol/L.

In some embodiments of the present disclosure, in S1, a molar ratio of barium to a total of nickel, cobalt, and aluminum in the mixed metal solution may be (5-15):100.

In some embodiments of the present disclosure, in S1, after the urea is added, a concentration of the urea in a resulting solution may be 2.0 mol/L to 5.0 mol/L.

In some embodiments of the present disclosure, in S1, the hydrothermal reaction may be conducted at 100° C. to 180° C. for 1 h to 4 h.

In some embodiments of the present disclosure, the reactions in S1 and S2 may be conducted in a high-pressure reactor. In S1, the mixed metal solution may be added to the high-pressure reactor at an amount ⅗ to ⅘ of a volume of the high-pressure reactor, and then the urea may be added to the high-pressure reactor.

In some embodiments of the present disclosure, in S2, the further reaction may be conducted at 60° C. to 80° C. for 24 h to 48 h.

In some embodiments of the present disclosure, in S3, a total concentration of metal ions in the second nickel-cobalt-aluminum mixed solution may be 1.0 mol/L to 2.0 mol/L.

In some embodiments of the present disclosure, in S3, the sodium hydroxide solution fed concurrently may have a concentration of 4.0 mol/L to 10.0 mol/L.

In some embodiments of the present disclosure, in S3, the aqueous ammonia fed concurrently may have a concentration of 6.0 mol/L to 12.0 mol/L, and the aqueous ammonia may serve as a complexing agent.

In some embodiments of the present disclosure, in S3, the base solution may have a pH of 10.8 to 11.5 and an ammonia concentration of 2.0 g/L to 5.0 g/L.

In some embodiments of the present disclosure, in S3, the reaction may be conducted at a temperature of 45° C. to 65° C., a pH of 10.8 to 11.5, and an ammonia concentration of 2.0 g/L to 5.0 g/L.

The present disclosure also provides use of the NCA cathode material precursor with a core-shell structure described above in an LIB.

According to a preferred embodiment of the present disclosure, the present disclosure at least has the following beneficial effects.
1. In the present disclosure, a nickel-cobalt-aluminum-barium mixed precipitate is first prepared by a first hydrothermal reaction, then barium is removed through a second hydrothermal reaction to obtain a nickel-cobalt-aluminum precipitate core, and finally a shell is formed on the core through co-precipitation method to obtain the NCA cathode material precursor with a core-shell structure. In the precursor, the core has a high nickel content and is porous, which can effectively buffer a volume change caused by the subsequent charge and discharge of an NCA cathode material; and the shell is a low-nickel material, which alleviates a volume change caused by a high nickel content.
2. During the hydrothermal reaction process to synthesize the core, a porous structure of the core material is formed according to the principle that barium carbonate is first precipitated and then dissolved; and during the reaction, due to the addition of carbon dioxide, nickel and cobalt exist in the form of carbonate. The reaction principle is as follows.

The first hydrothermal reaction is as follows:
CO(NH₂)₂+H₂O→2NH₃+CO₂;
NH₃·H₂O→NH₄⁺+OH⁻;
CO₂+H₂O→CO₃²⁻+2H⁺;
xNi²⁺+yCo²⁺+(1−0.5p)CO₃²⁻+pOH⁻→NiₓCo_{y}(OH)ₚ(CO₃)_{1-0.5p};
Al³⁺+3OH⁻→Al(OH)₃; and
Ba²⁺+CO₃²⁻→BaCO₃.

The high-pressure hydrothermal reaction after introducing carbon dioxide is as follows:
NiₓCo_{y}(OH)ₚ(CO₃)_{1-0.5p}+0.5pCO₂→NiₓCo_{y}CO₃+0.5H₂O; and
BaCO₃+CO₂+H₂O→Ba(HCO₃)₂.

### BRIEF DESCRIPTION OF THE DRAWINGS

The present disclosure is further described below with reference to accompanying drawings and examples.

FIG. 1 is a scanning electron microscopy (SEM) image of the NCA precursor material prepared in Example 1 of the present disclosure.

### DETAILED DESCRIPTION

The concepts and technical effects of the present disclosure are clearly and completely described below in conjunction with examples, such as to allow the objectives, features and effects of the present disclosure to be fully understood. Apparently, the described examples are merely some rather than all of the examples of the present disclosure. All other examples obtained by those skilled in the art based on the examples of the present disclosure without creative efforts should fall within the protection scope of the present disclosure.

### EXAMPLE 1

An NCA cathode material precursor with a core-shell structure was prepared in this example, and a specific preparation process was as follows:
Step 1. According to a required molar ratio of nickel, to cobalt, and to aluminum, namely, 0.95:0.02:0.03, nickel nitrate, cobalt nitrate, and aluminum nitrate were weighed to prepare a mixed salt solution in which a total concentration of metal ions was 0.1 mol/L.
Step 2. Barium nitrate was added to the mixed salt solution at an amount enabling a barium ion concentration to be 0.01 mol/L.
Step 3. The mixed salt solution was added to a high-pressure reactor at an amount ⅗ of a volume of the high-pressure reactor.
Step 4. Urea was added to the high-pressure reactor at an amount enabling a urea concentration to be 4.0 mol/L.
Step 5. The high-pressure reactor was heated to 140° C. and kept at the temperature for 2 h.
Step 6. After a reaction in step 5 was completed, carbon dioxide was introduced into the high-pressure reactor, and a further reaction was conducted for 36 h at 70° C. and 4.0 MPa.
Step 7. After the further reaction was completed, a reacted system was cooled to room temperature, then the pressure was released, the reacted system was subjected to SLS, and a resulting solid product was washed with pure water and taken as a core for later use.
Step 8. According to a required molar ratio of nickel, to cobalt, and to aluminum, namely, 0.55:0.2:0.25, nickel nitrate, cobalt nitrate, and aluminum nitrate were weighed to prepare a nickel-cobalt-aluminum mixed solution in which a total concentration of metal ions was 1.5 mol/L.
Step 9. A sodium hydroxide solution with a concentration of 8.0 mol/L was prepared.
Step 10. Aqueous ammonia with a concentration of 9.0 mol/L was prepared as a complexing agent.
Step 11. A base solution (the base solution was a mixed solution of sodium hydroxide and aqueous ammonia, and had a pH of 11.2 and an ammonia concentration of 4.0 g/L) was added to a reactor until a stirring paddle at a bottom was immersed, then the core prepared in step 7 was added, and stirring was started.
Step 12. The nickel-cobalt-aluminum mixed solution prepared in step 8, the sodium hydroxide solution prepared in step 9, and the aqueous ammonia prepared in step 10 were concurrently fed into the reactor to allow a reaction at a temperature of 55° C., a pH of 11.2, and an ammonia concentration of 4.0 g/L.
Step 13. When it was detected that D50 of a material in the reactor reached 6.5 μm, the feeding was stopped.
Step 14. The system in the reactor was subjected to SLS, and a resulting solid product was washed with pure water.
Step 15. The washed solid product was dried, sieved, and demagnetized in sequence to obtain the NCA cathode material precursor with a core-shell structure.

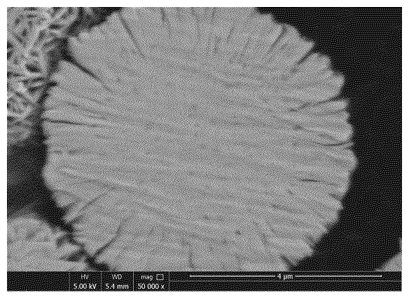

The particle appearance of the precursor was tested by SEM, as shown in FIG. 1; the particle size D50 was tested by a laser particle size analyzer; and the surface porosity was tested for the core by the matlab method. Test results were as follows.

The precursor was a spherical or spheroidal particle, with a D50 of 6.5 μm; the precursor particle was consisting of a shell and a core; the shell had a chemical formula of Ni_{0.55}Co_{0.2}Al_{0.25}(OH)_{2.25}; the core had a chemical formula of Ni_{0.95}Co_{0.02}Al_{0.03}(CO₃)_{0.97}(OH)_{0.09}; and the core was loose and porous, and had a porosity of 23.6% and a D50 of 4.0 μm.

### EXAMPLE 2

An NCA cathode material precursor with a core-shell structure was prepared in this example, and a specific preparation process was as follows:
Step 1. According to a required molar ratio of nickel, to cobalt, and to aluminum, namely, 0.85:0.05:0.1, nickel chloride, cobalt chloride, and aluminum chloride were weighed to prepare a mixed salt solution in which a total concentration of metal ions was 0.3 mol/L.
Step 2. Barium chloride was added to the mixed salt solution at an amount enabling a barium ion concentration to be 0.045 mol/L.
Step 3. The mixed salt solution was added to a high-pressure reactor at an amount ⅗ of a volume of the high-pressure reactor.
Step 4. Urea was added to the high-pressure reactor at an amount enabling a urea concentration to be 2.0 mol/L.
Step 5. The high-pressure reactor was heated to 100° C. and kept at the temperature for 3 h.
Step 6. After a reaction in step 5 was completed, carbon dioxide was introduced into the high-pressure reactor, and a further reaction was conducted for 48 h at 80° C. and 5.0 MPa.
Step 7. After the further reaction was completed, a reacted system was cooled to room temperature, then the pressure was released, the reacted system was subjected to SLS, and a resulting solid product was washed with pure water and taken as a core for later use.
Step 8. According to a required molar ratio of nickel, to cobalt, and to aluminum, namely, 0.45:0.2:0.35, nickel chloride, cobalt chloride, and aluminum chloride were weighed to prepare a nickel-cobalt-aluminum mixed solution in which a total concentration of metal ions was 2.0 mol/L.
Step 9. A sodium hydroxide solution with a concentration of 10.0 mol/L was prepared.
Step 10. Aqueous ammonia with a concentration of 12.0 mol/L was prepared as a complexing agent.
Step 11. A base solution (the base solution was a mixed solution of sodium hydroxide and aqueous ammonia, and had a pH of 11.5 and an ammonia concentration of 5.0 g/L) was added to a reactor until a stirring paddle at a bottom was immersed, then the core prepared in step 7 was added, and stirring was started.
Step 12. The nickel-cobalt-aluminum mixed solution prepared in step 8, the sodium hydroxide solution prepared in step 9, and the aqueous ammonia prepared in step 10 were concurrently fed into the reactor to allow a reaction at a temperature of 65° C., a pH of 11.5, and an ammonia concentration of 5.0 g/L.
Step 13. When it was detected that D50 of a material in the reactor reached 6.0 μm, the feeding was stopped.
Step 14. The system in the reactor was subjected to SLS, and a resulting solid product was washed with pure water.
Step 15. The washed solid product was dried, sieved, and demagnetized in sequence to obtain the NCA cathode material precursor with a core-shell structure.

The particle appearance of the precursor was tested by SEM; the particle size D50 was tested by a laser particle size analyzer; and the surface porosity was tested for the core by the matlab method. Test results were as follows.

The precursor was a spherical or spheroidal particle, with a D50 of 6.0 μm; the precursor particle was consisting of a shell and a core; the shell had a chemical formula of Ni_{0.45}Co_{0.2}Al_{0.35}(OH)_{2.35}; the core had a chemical formula of Ni_{0.85}Co_{0.05}Al_{0.1}(CO₃)_{0.9}(OH)_{0.3}; and the core was loose and porous, and had a porosity of 37% and a D50 of 4.5 μm.

### EXAMPLE 3

An NCA cathode material precursor with a core-shell structure was prepared in this example, and a specific preparation process was as follows:
Step 1. According to a required molar ratio of nickel, to cobalt, and to aluminum, namely, 0.9:0.05:0.05, soluble salts of nickel nitrate, cobalt nitrate, and aluminum nitrate were weighed to prepare a mixed salt solution in which a total concentration of metal ions was 1.0 mol/L.
Step 2. Barium nitrate was added to the mixed salt solution at an amount enabling a barium ion concentration to be 0.05 mol/L.
Step 3. The mixed salt solution was added to a high-pressure reactor at an amount ⅘ of a volume of the high-pressure reactor.
Step 4. Urea was added to the high-pressure reactor at an amount enabling a urea concentration to be 5.0 mol/L.
Step 5. The high-pressure reactor was heated to 180° C. and kept at the temperature for 1 h.
Step 6. After a reaction in step 5 was completed, carbon dioxide was introduced into the high-pressure reactor, and a further reaction was conducted for 24 h at 60° C. and 3.0 MPa.
Step 7. After the further reaction was completed, a reacted system was cooled to room temperature, then the pressure was released, the reacted system was subjected to SLS, and a resulting solid product was washed with pure water and taken as a core for later use.
Step 8. According to a required molar ratio of nickel, to cobalt, and to aluminum, namely, 0.5:0.2:0.3, nickel nitrate, cobalt nitrate, and aluminum nitrate were weighed to prepare a nickel-cobalt-aluminum mixed solution in which a total concentration of metal ions was 1.0 mol/L.
Step 9. A sodium hydroxide solution with a concentration of 4.0 mol/L was prepared.
Step 10. Aqueous ammonia with a concentration of 6.0 mol/L was prepared as a complexing agent.
Step 11. A base solution (the base solution was a mixed solution of sodium hydroxide and aqueous ammonia, and had a pH of 10.8 and an ammonia concentration of 2.0 g/L) was added to a reactor until a stirring paddle at a bottom was immersed, then the core prepared in step 7 was added, and stirring was started.
Step 12. The nickel-cobalt-aluminum mixed solution prepared in step 8, the sodium hydroxide solution prepared in step 9, and the aqueous ammonia prepared in step 10 were concurrently fed into the reactor to allow a reaction at a temperature of 45° C., a pH of 10.8, and an ammonia concentration of 2.0 g/L.
Step 13. When it was detected that D50 of a material in the reactor reached 10.5 μm, the feeding was stopped.
Step 14. The system in the reactor was subjected to SLS, and a resulting solid product was washed with pure water.
Step 15. The washed solid product was dried, sieved, and demagnetized in sequence to obtain the NCA cathode material precursor with a core-shell structure.

The particle appearance of the precursor was tested by SEM; the particle size D50 was tested by a laser particle size analyzer; and the surface porosity was tested for the core by the matlab method. Test results were as follows.

The precursor was a spherical or spheroidal particle, with a D50 of 10.5 μm; the precursor particle was consisting of a shell and a core; the shell had a chemical formula of Ni_{0.5}Co_{0.2}Al_{0.3}(OH)_{2.3}; the core had a chemical formula of Ni_{0.9}Co_{0.05}Al_{0.05}(CO₃)_{0.95}(OH)_{0.15}; and the core was loose and porous, and had a porosity of 15% and a D50 of 2.5 μm.

### COMPARATIVE EXAMPLE 1

An NCA cathode material precursor with a core-shell structure was prepared in this comparative example, which was different from Example 1 in that no barium nitrate was added. A specific preparation process was as follows:
Step 1. According to a required molar ratio of nickel, to cobalt, and to aluminum, namely, 0.95:0.02:0.03, nickel nitrate, cobalt nitrate, and aluminum nitrate were weighed to prepare a mixed salt solution in which a total concentration of metal ions was 0.1 mol/L.
Step 2. The mixed salt solution was added to a high-pressure reactor at an amount ⅗ of a volume of the high-pressure reactor.
Step 3. Urea was added to the high-pressure reactor at an amount enabling a urea concentration to be 4.0 mol/L.
Step 4. The high-pressure reactor was heated to 140° C. and kept at the temperature for 2h.
Step 5. After a reaction in step 4 was completed, carbon dioxide was introduced into the high-pressure reactor, and a further reaction was conducted for 36 h at 70° C. and 4.0 MPa.
Step 6. After the further reaction was completed, a reacted system was cooled to room temperature, then the pressure was released, the reacted system was subjected to SLS, and a resulting solid product was washed with pure water and taken as a core for later use.
Step 7. According to a required molar ratio of nickel, to cobalt, and to aluminum, namely, 0.55:0.2:0.25, nickel nitrate, cobalt nitrate, and aluminum nitrate were weighed to prepare a nickel-cobalt-aluminum mixed solution in which a total concentration of metal ions was 1.5 mol/L.
Step 8. A sodium hydroxide solution with a concentration of 8.0 mol/L was prepared.
Step 9. Aqueous ammonia with a concentration of 9.0 mol/L was prepared as a complexing agent.
Step 10. A base solution (the base solution was a mixed solution of sodium hydroxide and aqueous ammonia, and had a pH of 11.2 and an ammonia concentration of 4.0 g/L) was added to a reactor until a stirring paddle at a bottom was immersed, then the core prepared in step 6 was added, and stirring was started.
Step 11. The nickel-cobalt-aluminum mixed solution prepared in step 7, the sodium hydroxide solution prepared in step 8, and the aqueous ammonia prepared in step 9 were concurrently fed into the reactor to allow a reaction at a temperature of 55° C., a pH of 11.2, and an ammonia concentration of 4.0 g/L.
Step 12. When it was detected that D50 of a material in the reactor reached 6.5 μm, the feeding was stopped.
Step 13. The system in the reactor was subjected to SLS, and a resulting solid product was washed with pure water.
Step 14. The washed solid product was dried, sieved, and demagnetized in sequence to obtain the NCA cathode material precursor with a core-shell structure.

The particle appearance of the precursor was tested by SEM; the particle size D50 was tested by a laser particle size analyzer; and the surface porosity was tested for the core by the matlab method. Test results were as follows.

The precursor was a spherical or spheroidal particle, with a D50 of 6.5 μm; the precursor particle was consisting of a shell and a core; the shell had a chemical formula of Ni_{0.55}Co_{0.2}Al_{0.25}(OH)_{2.25}; the core had a chemical formula of Ni_{0.95}Co_{0.02}Al_{0.03}(CO₃)_{0.97}(OH)_{0.09}; and the core had a porosity of 3.7% and a D50 of 4.0 μm.

### COMPARATIVE EXAMPLE 2

An NCA cathode material precursor with a core-shell structure was prepared in this comparative example, which was different from Example 2 in that no barium chloride was added. A specific preparation process was as follows:
Step 1. According to a required molar ratio of nickel, to cobalt, and to aluminum, namely, 0.85:0.05:0.1, nickel chloride, cobalt chloride, and aluminum chloride were weighed to prepare a mixed salt solution in which a total concentration of metal ions was 0.3 mol/L.
Step 2. The mixed salt solution was added to a high-pressure reactor at an amount ⅗ of a volume of the high-pressure reactor.
Step 3. Urea was added to the high-pressure reactor at an amount enabling a urea concentration to be 2.0 mol/L.
Step 4. The high-pressure reactor was heated to 100° C. and kept at the temperature for 3h.
Step 5. After a reaction in step 4 was completed, carbon dioxide was introduced into the high-pressure reactor, and a further reaction was conducted for 48 h at 80° C. and 5.0 MPa.
Step 6. After the further reaction was completed, a reacted system was cooled to room temperature, then the pressure was released, the reacted system was subjected to SLS, and a resulting solid product was washed with pure water and taken as a core for later use.
Step 7. According to a required molar ratio of nickel, to cobalt, and to aluminum, namely, 0.45:0.2:0.35, nickel chloride, cobalt chloride, and aluminum chloride were weighed to prepare a nickel-cobalt-aluminum mixed solution in which a total concentration of metal ions was 2.0 mol/L.
Step 8. A sodium hydroxide solution with a concentration of 10.0 mol/L was prepared.
Step 9. Aqueous ammonia with a concentration of 12.0 mol/L was prepared as a complexing agent.
Step 10. A base solution (the base solution was a mixed solution of sodium hydroxide and aqueous ammonia, and had a pH of 11.5 and an ammonia concentration of 5.0 g/L) was added to a reactor until a stirring paddle at a bottom was immersed, then the core prepared in step 6 was added, and stirring was started.
Step 11. The nickel-cobalt-aluminum mixed solution prepared in step 7, the sodium hydroxide solution prepared in step 8, and the aqueous ammonia prepared in step 9 were concurrently fed into the reactor to allow a reaction at a temperature of 65° C., a pH of 11.5, and an ammonia concentration of 5.0 g/L.
Step 12. When it was detected that D50 of a material in the reactor reached 6.0 μm, the feeding was stopped.
Step 13. The system in the reactor was subjected to SLS, and a resulting solid product was washed with pure water.
Step 14. The washed solid product was dried, sieved, and demagnetized in sequence to obtain the NCA cathode material precursor with a core-shell structure.

The particle appearance of the precursor was tested by SEM; the particle size D50 was tested by a laser particle size analyzer; and the surface porosity was tested for the core by the matlab method. Test results were as follows.

The precursor was a spherical or spheroidal particle, with a D50 of 6.0 μm; the precursor particle was consisting of a shell and a core; the shell had a chemical formula of Ni_{0.45}Co_{0.2}Al_{0.35}(OH)_{2.35}; the core had a chemical formula of Ni_{0.85}Co_{0.05}Al_{0.1}(CO₃)_{0.9}(OH)_{0.3}; and the core had a porosity of 1.3% and a D50 of 4.5 μm.

### COMPARATIVE EXAMPLE 3

An NCA cathode material precursor with a core-shell structure was prepared in this comparative example, which was different from Example 3 in that no barium nitrate was added. A specific preparation process was as follows:
Step 1. According to a required molar ratio of nickel, to cobalt, and to aluminum, namely, 0.9:0.05:0.05, soluble salts of nickel nitrate, cobalt nitrate, and aluminum nitrate were weighed to prepare a mixed salt solution in which a total concentration of metal ions was 1.0 mol/L.
Step 2. The mixed salt solution was added to a high-pressure reactor at an amount ⅘ of a volume of the high-pressure reactor.
Step 3. Urea was added to the high-pressure reactor at an amount enabling a urea concentration to be 5.0 mol/L.
Step 4. The high-pressure reactor was heated to 180° C. and kept at the temperature for 1 h.
Step 5. After a reaction in step 4 was completed, carbon dioxide was introduced into the high-pressure reactor, and a further reaction was conducted for 24 h at 60° C. and 3.0 MPa.
Step 6. After the further reaction was completed, a reacted system was cooled to room temperature, then the pressure was released, the reacted system was subjected to SLS, and a resulting solid product was washed with pure water and taken as a core for later use.
Step 7. According to a required molar ratio of nickel, to cobalt, and to aluminum, namely, 0.5:0.2:0.3, nickel nitrate, cobalt nitrate, and aluminum nitrate were weighed to prepare a nickel-cobalt-aluminum mixed solution in which a total concentration of metal ions was 1.0 mol/L.
Step 8. A sodium hydroxide solution with a concentration of 4.0 mol/L was prepared.
Step 9. Aqueous ammonia with a concentration of 6.0 mol/L was prepared as a complexing agent.
Step 10. A base solution (the base solution was a mixed solution of sodium hydroxide and aqueous ammonia, and had a pH of 10.8 and an ammonia concentration of 2.0 g/L) was added to a reactor until a stirring paddle at a bottom was immersed, then the core prepared in step 6 was added, and stirring was started.
Step 11. The nickel-cobalt-aluminum mixed solution prepared in step 7, the sodium hydroxide solution prepared in step 8, and the aqueous ammonia prepared in step 9 were concurrently fed into the reactor to allow a reaction at a temperature of 45° C., a pH of 10.8, and an ammonia concentration of 2.0 g/L.
Step 12. When it was detected that D50 of a material in the reactor reached 10.5 μm, the feeding was stopped.
Step 13. The system in the reactor was subjected to SLS, and a resulting solid product was washed with pure water.
Step 14. The washed solid product was dried, sieved, and demagnetized in sequence to obtain the NCA cathode material precursor with a core-shell structure.

The particle appearance of the precursor was tested by SEM; the particle size D50 was tested by a laser particle size analyzer; and the surface porosity was tested for the core by the matlab method. Test results were as follows.

The precursor was a spherical or spheroidal particle, with a D50 of 10.5 μm; the precursor particle was consisting of a shell and a core; the shell had a chemical formula of Ni_{0.5}Co_{0.2}Al_{0.3}(OH)_{2.3}; the core had a chemical formula of Ni_{0.9}Co_{0.05}Al_{0.05}(CO₃)_{0.95}(OH)_{0.15}; and the core had a porosity of 2.2% and a D50 of 2.5 μm.

### TEST EXAMPLE

The NCA cathode material precursors obtained in Examples 1 to 3 and Comparative Examples 1 to 3 were each thoroughly mixed with lithium hydroxide according to a molar ratio of lithium to a total of nickel, cobalt, and aluminum being 1.08:1, and a resulting mixture was then calcined at 800° C. for 12 h in an oxygen atmosphere to obtain a corresponding cathode material.

The cathode material obtained above was used to assemble a button battery, and the battery was subjected to an electrochemical performance test. Specifically, with N-methylpyrrolidone (NMP) as a solvent, a cathode active material, acetylene black, and polyvinylidene fluoride (PVDF) were thoroughly mixed in a mass ratio of 8:1:1, coated on an aluminum foil, blow-dried at 80° C. for 8 h, and then vacuum-dried at 120° C. for 12 h; and then a battery was assembled in an argon-protected glove box, with a lithium sheet as a negative electrode, a polypropylene (PP) membrane as a separator, and 1 M LiPF₆-EC/DMC (1:1, v/v) as an electrolyte. The electrochemical performance test was conducted at a charge/discharge cut-off voltage of 2.7 V to 4.3 V. The cycling performance at a current density of 0.1 C was tested, and test results were shown in Table 1.

TABLE 1

| | | Specific discharge | |
|---|---|---|---|
| | Discharge capacity | capacity after | Cycling |
| | at 0.1 C, mAh/g | 100 cycles, mAh/g | retention rate |
| Example 1 | 226.2 | 214.1 | 94.7% |
| Comparative | 228.3 | 199.7 | 87.5% |
| Example 1 | | | |
| Example 2 | 208.0 | 198.6 | 95.5% |
| Comparative | 211.6 | 187.2 | 88.5% |
| Example 2 | | | |
| Example 3 | 219.2 | 208.7 | 95.2% |
| Comparative | 220.4 | 193.8 | 87.9% |
| Example 3 | | | |

It can be seen from Table 1 that the initial discharge capacity of the comparative examples was comparable to the initial discharge capacity of the examples, but the specific capacity of the comparative examples was significantly lower than the specific capacity of the examples after 100 cycles, indicating that the cycling performance of the comparative examples was poor. This was because the cores of the comparative examples were made of high-nickel materials and had too-compact internal structures, which enlarged a volume change caused by charge and discharge, thereby affecting the cycling performance.

The examples of the present disclosure are described in detail with reference to the accompanying drawings, but the present disclosure is not limited to the above examples. Within the scope of knowledge possessed by those of ordinary skill in the technical field, various changes can also be made without departing from the purpose of the present disclosure. In addition, the examples and features in the examples in the present disclosure may be combined with each other in a non-conflicting situation.

1. A nickel-cobalt-aluminum (NCA) cathode material precursor with a core-shell structure, wherein the NCA cathode material precursor is a spherical or spheroidal particle and is consisting of a shell and a core; the shell has a general chemical formula of NiₐCo_{b}Al_{c}(OH)_{2+c}, wherein a+b+c=1, 0.45≤a≤0.55, 0.15≤b≤0.25, and 0.25≤c≤0.35; the core has a general chemical formula of NiₓCo_{y}Al_{z}(CO₃)_{1-z}(OH)_{3z}, wherein x+y+z=1, 0.85≤x≤0.98, 0<y≤0.15, and 0<z≤0.15; and the core has a porous structure, with a porosity of 15% to 45%.

2. The NCA cathode material precursor with a core-shell structure according to claim 1, wherein the NCA cathode material precursor has a particle size D50 of 5.0 μm to 15.0 μm, and D50 of the core is 2.0 μm to 5.0 μm.

3. A preparation method of the NCA cathode material precursor with a core-shell structure according to claim 1, comprising the following steps:
S1: adding a soluble barium salt to a first nickel-cobalt-aluminum mixed solution to obtain a mixed metal solution, mixing the mixed metal solution with urea, and allowing a hydrothermal reaction, wherein nickel, cobalt, and aluminum in the first nickel-cobalt-aluminum mixed solution are in a molar ratio of x:y:z;
S2: after the hydrothermal reaction in S1 is completed, introducing carbon dioxide into a reacted system to allow a further reaction under a pressure of 3.0 MPa to 5.0 MPa, and after the further reaction is completed, conducting solid-liquid separation (SLS) to obtain the core; and
S3: adding the core to a base solution, concurrently feeding a second nickel-cobalt-aluminum mixed solution, a sodium hydroxide solution, and aqueous ammonia to allow a reaction, and when a particle size of a product of the reaction reaches a target value, conducting SLS to obtain the NCA cathode material precursor, wherein the base solution is a mixed solution of sodium hydroxide and aqueous ammonia, and nickel, cobalt, and aluminum in the second nickel-cobalt-aluminum mixed solution are in a molar ratio of a:b:c.

4. The preparation method according to claim 3, wherein in S1, a total concentration of metal ions in the first nickel-cobalt-aluminum mixed solution is 0.1 mol/L to 1.0 mol/L.

5. The preparation method according to claim 3, wherein in S1, a molar ratio of barium to a total of nickel, cobalt, and aluminum in the mixed metal solution is (5-15):100.

6. The preparation method according to claim 3, wherein in S1, after the urea is added, a concentration of the urea in a resulting solution is 2.0 mol/L to 5.0 mol/L.

7. The preparation method according to claim 3, wherein in S1, the hydrothermal reaction is conducted at 100° C. to 180° C. for 1 h to 4 h.

8. The preparation method according to claim 3, wherein in S2, the further reaction is conducted at 60° C. to 80° C. for 24 h to 48 h.

9. The preparation method according to claim 3, wherein in S3, a total concentration of metal ions in the second nickel-cobalt-aluminum mixed solution is 1.0 mol/L to 2.0 mol/L.

10. Use of the NCA cathode material precursor with a core-shell structure according to claim 1 in a lithium-ion battery.

11. A preparation method of the NCA cathode material precursor with a core-shell structure according to claim 2, comprising the following steps:
S1: adding a soluble barium salt to a first nickel-cobalt-aluminum mixed solution to obtain a mixed metal solution, mixing the mixed metal solution with urea, and allowing a hydrothermal reaction, wherein nickel, cobalt, and aluminum in the first nickel-cobalt-aluminum mixed solution are in a molar ratio of x:y:z;
S2: after the hydrothermal reaction in S1 is completed, introducing carbon dioxide into a reacted system to allow a further reaction under a pressure of 3.0 MPa to 5.0 MPa, and after the further reaction is completed, conducting solid-liquid separation (SLS) to obtain the core; and
S3: adding the core to a base solution, concurrently feeding a second nickel-cobalt-aluminum mixed solution, a sodium hydroxide solution, and aqueous ammonia to allow a reaction, and when a particle size of a product of the reaction reaches a target value, conducting SLS to obtain the NCA cathode material precursor, wherein the base solution is a mixed solution of sodium hydroxide and aqueous ammonia, and nickel, cobalt, and aluminum in the second nickel-cobalt-aluminum mixed solution are in a molar ratio of a:b:c.

12. The preparation method according to claim 11, wherein in S1, a total concentration of metal ions in the first nickel-cobalt-aluminum mixed solution is 0.1 mol/L to 1.0 mol/L.

13. The preparation method according to claim 11, wherein in S1, a molar ratio of barium to a total of nickel, cobalt, and aluminum in the mixed metal solution is (5-15):100.

14. The preparation method according to claim 11, wherein in S1, after the urea is added, a concentration of the urea in a resulting solution is 2.0 mol/L to 5.0 mol/L.

15. The preparation method according to claim 11, wherein in S1, the hydrothermal reaction is conducted at 100° C. to 180° C. for 1 h to 4 h.

16. The preparation method according to claim 11, wherein in S2, the further reaction is conducted at 60° C. to 80° C. for 24 h to 48 h.

17. The preparation method according to claim 11, wherein in S3, a total concentration of metal ions in the second nickel-cobalt-aluminum mixed solution is 1.0 mol/L to 2.0 mol/L.

18. Use of the NCA cathode material precursor with a core-shell structure according to claim 2 in a lithium-ion battery.
